(19) United States
(12) Patent Application Publication
(10) Pub. No.: US 2019/0362029 A1
(43) Pub. Date: Nov. 28, 2019

(54) SYSTEMS AND METHODS FOR LIGHTWEIGHT PRECISE 3D VISUAL FORMAT

(71) Applicant: Siemens Product Lifecycle Management Software Inc., Plano, TX (US)

(72) Inventors: Jianbing Huang, Shoreview, MN (US); Michael B. Carter, Ames, IA (US); Kang Li, Ames, IA (US)

(21) Appl. No.: 16/476,612

(22) PCT Filed: Sep. 7, 2017
(86) PCT No.: PCT/US2017/050456

§ 371 Date: Jul. 9, 2019

(51) Int. Cl. G06F 17/50; G06T 17/30; G06T 17/10; G06T 17/20

(52) U.S. Cl. CPC G06F 17/50; G06T 17/20; G06T 17/10; G06T 17/30

(57) ABSTRACT

Methods for creation, storage, and processing of CAD data, and corresponding systems and computer-readable mediums. A method includes producing a three-dimensional (3D) parameter space mesh representation of a computer-aided design (CAD) model. The 3D parameter space mesh representation includes a plurality of curve-based vertices and a plurality of surface-based vertices. Each curve-based vertex corresponds to a boundary-representation (B-Rep) curve and is represented by a reference to a curve of a surface of the 3D CAD model and by at least one curve parameter value. Each surface-based vertex corresponds to a B-Rep surface and is presented as a reference to a respective surface of the 3D CAD model and a plurality of parameters on the respective surface. The method includes storing the 3D parameter space mesh representation of the CAD model.

### TECHNICAL FIELD

The present disclosure is directed, in general, to computer-aided design (“CAD”), visualization, and manufacturing systems, product lifecycle management (“PLM”) systems, and similar systems, that manage data for products and other items (collectively, “Product Data Management” systems or PDM systems), and in particular to systems and methods for lightweight precise 3D visual format data storage and processing.

### BACKGROUND OF THE DISCLOSURE

CAD and PDM systems manage CAD and other data. Improved systems are desirable.

### SUMMARY OF THE DISCLOSURE

Various disclosed embodiments include methods for creation, storage, and processing of CAD data, and corresponding systems and computer-readable mediums. A method includes producing a three-dimensional parameter space mesh representation of a computer-aided design model. The 3D parameter space mesh representation includes a plurality of curve-based vertices and a plurality of surface-based vertices. Each curve-based vertex corresponds to a boundary-representation curve and is represented by a reference to a curve of a surface of the 3D CAD model and by at least one curve parameter value. Each surface-based vertex corresponds to a B-Rep surface and is presented as a reference to a respective surface of the 3D CAD model and a plurality of parameters on the respective surface. The method includes storing the 3D parameter space mesh representation of the CAD model.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an ultra-lightweight precise format in accordance with disclosed embodiments;

FIG. 2 illustrates the exclusion of model space curves in an ULP2 B-Rep in accordance with disclosed embodiments;

FIG. 3 illustrates a parameter space mesh in accordance with disclosed embodiments;

FIG. 4 illustrates an evaluation of a model space mesh from a parameter space mesh, in accordance with disclosed embodiments;

FIG. 5 illustrates evaluation of curve-based vertices to avoid cracks in accordance with disclosed embodiments;

FIG. 6 illustrates an example of a process to determine or add new curve-based vertices between two curve-based vertices to refine a mesh, in accordance with disclosed embodiments;

FIG. 7 illustrates an example of a process to determine or add new surface-based vertices between two surface-based vertices to refine a mesh, in accordance with disclosed embodiments;

FIG. 8 illustrates a process of computing geometry of new vertices in different cases in accordance with disclosed embodiments;

FIG. 9 illustrates that the fidelity of the refined mesh is controlled by two parameters, in accordance with disclosed embodiments;

FIG. 10 illustrates a B-Rep mesh based on mesh refinement, according to disclosed embodiments;

FIG. 11 illustrates a process in accordance with disclosed embodiments that uses a hybrid of specialized tessellation and facet split;

FIGS. 12A and 12B illustrate and compare two ways of connecting new vertices with existing vertices in accordance with disclosed embodiments;

FIG. 13A-13C illustrate three cases of triangle splitting in accordance with disclosed embodiments;

FIGS. 14A-14C illustrate optimal techniques for triangle splitting with new vertices using geometry-driven connectivity computation in accordance with disclosed embodiments;

FIG. 15 illustrates a process for propagation of a refinement result from one surface to an adjacent surface, in accordance with disclosed embodiments;

FIG. 16 illustrates a B-Rep with sample points in the parameter space mesh, in accordance with disclosed embodiments;

FIG. 17 illustrates a polygon mesh representation in accordance with disclosed embodiments;

FIG. 18 illustrates a technique for serializing a mesh representation in accordance with disclosed embodiments;

FIG. 19 illustrates ordering of vertex records in accordance with disclosed embodiments;

FIG. 20 illustrates index based vertex geometry with reference to parameter value tables, in accordance with disclosed embodiments;

FIG. 21 illustrates compression-friendly vertex geometry representations with relative indices in accordance with disclosed embodiments;

FIG. 22 illustrates polygon mesh serialization using relative indices in accordance with disclosed embodiments;

FIG. 23 illustrates a process for computing a vertex index list and vertex record table during polygon mesh deserialization from three relative index arrays, in accordance with disclosed embodiments

FIG. 24 shows an example of computing a vertex index list and vertex record table in accordance with disclosed embodiments;

FIG. 25 depicts a flowchart of a process in accordance with disclosed embodiments; and

FIG. 26 illustrates a block diagram of a data processing system in which an embodiment can be implemented.

### DETAILED DESCRIPTION

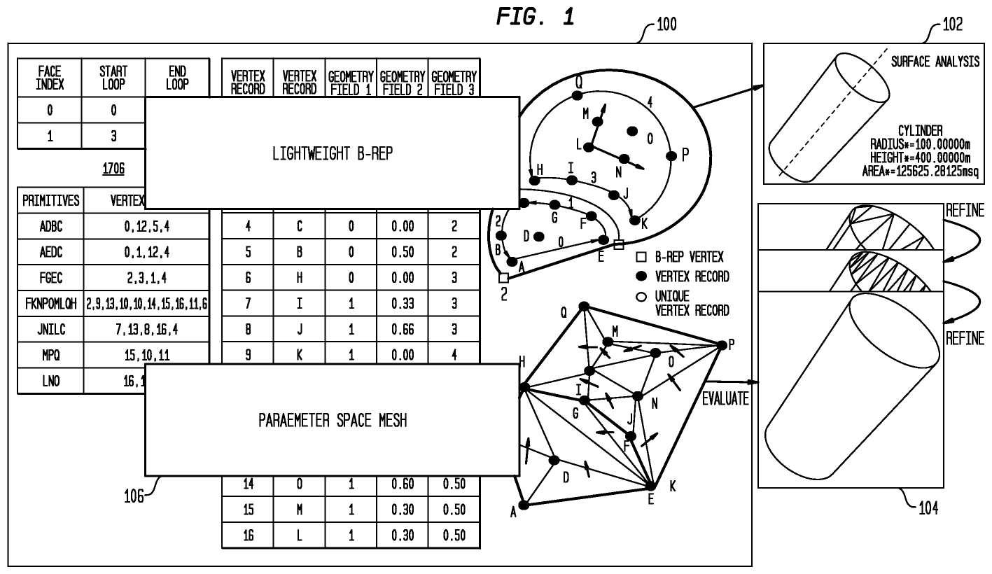

FIGS. 1 through 26, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Collaborative visualization of three-dimensional (3D) design information plays an important role in the PLM environment of an extended enterprise, where effective communication of 3D product information, between different organizations that are functionally heterogeneous and physically distributed, is essential. If one picture is worth a thousand words, the availability of 3D visual information can be worth a thousand pictures. While 3D information has mostly been used for traditional engineering purposes such as design and manufacturing, its usage is quickly being expanded to many non-engineering activities in the product lifecycle, such as training, maintenance, and marketing. Therefore, easy availability of 3D visual information in the PLM environment carries great value to everyone's productivity in the extended enterprise.

In the PLM environment, 3D visual data is frequently vaulted on servers, and accessed by clients connected to the server via LAN or WAN. Usually the clients are located at various locations around the world and, for many clients, their corresponding servers are located remotely in a different geographic region or even a different country. Reducing the disk size of the 3D visual data improves its accessibility in the client-server architecture because the time needed to transmit the data from the server to the client, especially across a network with limited bandwidth, is reduced.

Therefore, characteristics a successful 3D visual format include high compression for lightweight storage on disk, and lightweight transport across networks, high performance display for large models, high quality display, especially when zoomed in, and support for accurate geometric analysis such as measurements.

Currently the mostly widely used 3D visual formats are based on triangle meshes, where the object shape is represented by a collection of planar triangle facets. For better rendering performance, several mesh representations of different fidelity, usually called Level-Of-Detail or LOD, for the same object geometry may simultaneously exist in the file so that the visualization engine can choose to render cheaper but less-detailed versions of objects that are considered visually less significant in the scene.

While LOD representation has the advantage of excellent rendering performance, especially with modern graphics hardware, it also has three major disadvantages as 3D visual representation. For example, LOD resolutions are fixed in the file, so curved surfaces may not appear smooth when zoomed in, creating undesirable visual artifacts. Flat facets in mesh representations are merely linear approximations to the real object geometry. Some geometric operations, such as derivative computation, may not be meaningful at all for meshes, and other geometric operations may not result in the needed accuracy. LOD representations can be heavy, resulting in large file size, even with state-of-art compression techniques, especially when the required precision of the LOD is high.

Boundary Representation, or B-Rep, is the de facto industry standard for 3D geometry representation in modern CAD packages. A B-Rep allows the representation of free-form curves and surfaces, usually in the form of NURBS (Non-Uniform Rational B-Spline), and can be used to accurately represent the 3D geometry design information. The major disadvantages of B-Reps as visual representations are that they require relatively significant amounts of storage on disk, and that they in general cannot be rendered directly by the graphics hardware.

The JT file format is a 3D model format developed by Siemens Product Lifecycle Management Software Inc. that was designed as an open, high-performance, compact, persistent storage format for product data. JT files are used for product visualization, collaboration and data sharing. JT files may contain approximate (faceted) data, exact boundary representation surfaces (NURBS), product and manufacturing information (PMI), and metadata. JT files can be exported by native CAD systems and imported by product data management (PDM) systems. Some aspects of JT file formats are described, for example, in U.S. Pat. No. 8,019,788, hereby incorporated by reference.

Enterprise JT files can include both B-Rep and LODs so that a model can be quickly visualized and these files support high accuracy analysis. To avoid excessively heavy JT file, only a limited number of LODs are included in the JT file. For example, a given JT file could include, for a model, a B-Rep and three LODs. How many LODs should be included in the JT file and how many triangles each LOD should have do not always have straightforward answers, as the answer largely depend on the envisioned usages of JT files. As a result different variations of JT files are created for different purposes, even by the same customer.

Disclosed embodiments can represent 3D visual information that is lightweight on disk (10% of typical enterprise JT), contains high precision curved geometry that is compatible with mainstream CAD B-Rep representation, and can be progressively refined.

Various approaches can be taken to address such issues. A first approach is first generation ultra-lightweight precise (ULP) format (referred to herein as ULP1) in JT, where 3D visual information is represented as compressed B-Rep. In such an approach, LODs are generated for display by tessellation when ULP is loaded. While ULP1 achieves small file size and retains good accuracy, its loading speed is not fast enough for large model visualization because tessellation is an expensive operation by nature.

Another approach is ATI TRUFORM approach by Advanced Micro Devices. This approach is triangle mesh based, meaning that the representation on disk is normal LOD. Curve and surface definition is constructed for each triangle in the mesh based on the coordinates and normal vectors of its three vertices. Refinement of the triangle mesh is then achieved by adding new samples along the edges of the triangle or in the interior of the triangle based on curve and surface. This approach has fundamental limitation in that the tangent continuity is maintained only at the vertex locations of the initial mesh. The surface geometry is not G1 continuous across triangle edges. This limitation can cause display artifacts. In addition the curved geometry that it forms can be quite different from B-Rep information, both in terms of data representation and data accuracy. For example a cylinder surface may be represented as a collection of triangular patches, and important information such as cylinder axis or radius is lost in such representation.

Disclosed embodiments include techniques used in second generation ULP (referred to herein as ULP2) in JT format. The approach differs from the existing approaches in that it provides the ability to quickly generate LODs of higher fidelity, while maintaining other desirable characteristics such as small file size and high data precision.

Disclosed embodiments can include a parameter space mesh representation that references to the B-Rep in such a way that the initial LOD can be quickly evaluated from parameter space mesh, and in addition the initial LOD can be quickly refined to generate LODs of higher fidelity.

FIG. 1 illustrates a second generation ultra-lightweight precise (ULP2) format in accordance with disclosed embodiments. Here, the file 100 includes a B-Rep portion 102 that includes a parameter space mesh representation 106 of the model. The B-Rep portion 102 can then be used to generate and refine LODs 104. Comparing with ULP1, the inclusion of parameter space mesh in the representation enables quick generation and refinement of LODs. Additionally due to tight coupling between parameter space representation and B-Rep that can be leveraged to facilitate better compression, ULP2 file size can still be made very small.

Another important aspect of disclosed embodiments is the ability to exclude model space curves in the B-Rep representation to make it lighter weight.

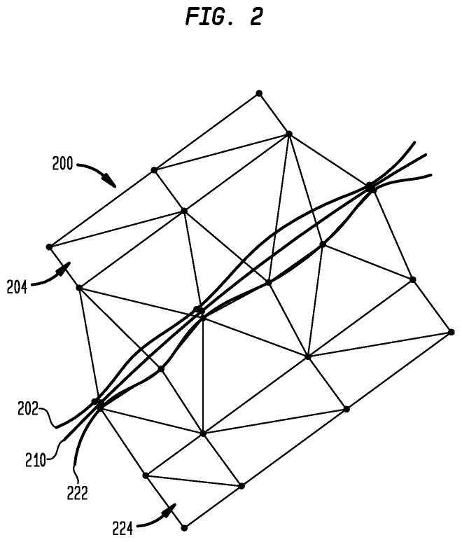

FIG. 2 illustrates the exclusion of model space curves in an ULP2 B-Rep in accordance with disclosed embodiments.

The model space curve geometry for a model 200 is instead defined by the “master” parameter space curves, as the parameter space curve 222 for “master” surface 224, together with the surface 224. The “master” parameter space curve can be arbitrarily designated as one of the two parameter space curves at the edge location. Shown here is also the parameter space curve 202 for surface 204. 3D curve 210 is not stored, contrary to conventional techniques. Such approximation to the model space curve is considered acceptable because model space curve is required to be very close to either parameter space curve in any valid B-Rep.

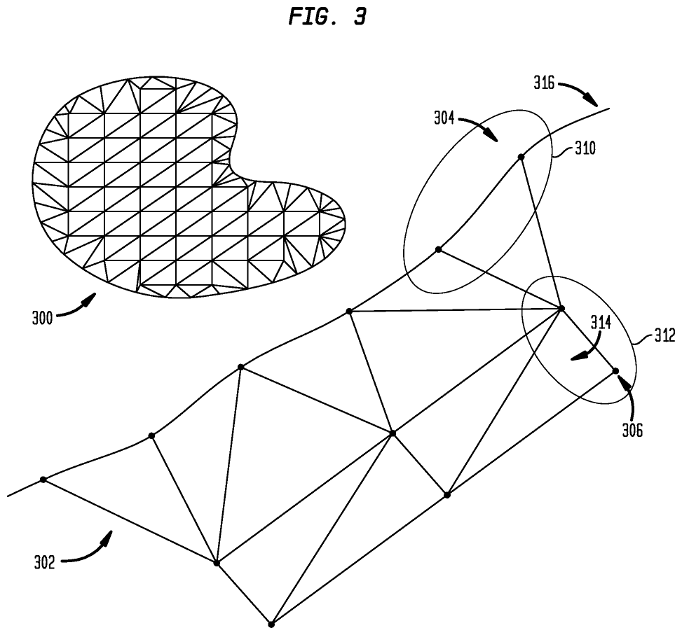

FIG. 3 illustrates a parameter space mesh in accordance with disclosed embodiments, with two types of vertices. This figure shows a closer view 302 of parameter space mesh 300. Area 310 illustrates a curve-based vertex 304, represented by a reference to curve C 316 of surface S, a curve parameter value t, where (u, v)=C (t) and (x, y, z)=S(u,v). Area 312 illustrates a surface-based vertex 306, represented by a reference to surface S 314 and surface parameter values u and v, where (x, y, z)=S(u,v). In such a case, parameter values t, u, v do not have to be represented very precisely, and the vertices in the interior of a face lie on a regular grid, so they can be represented very concisely.

The vertex geometry representation in a parameter space mesh differs depending on its type. For those vertices that correspond to B-Rep curves, shown as the “curve-based vertex” in area 310, the parameter space representation includes reference to the curve and the parameter on the curve. On the other hand, those vertices that were sampled from interior of a B-Rep surface, shown as the “surface-based vertex” in area 312, are represented as reference to the surface and two parameters on the surface.

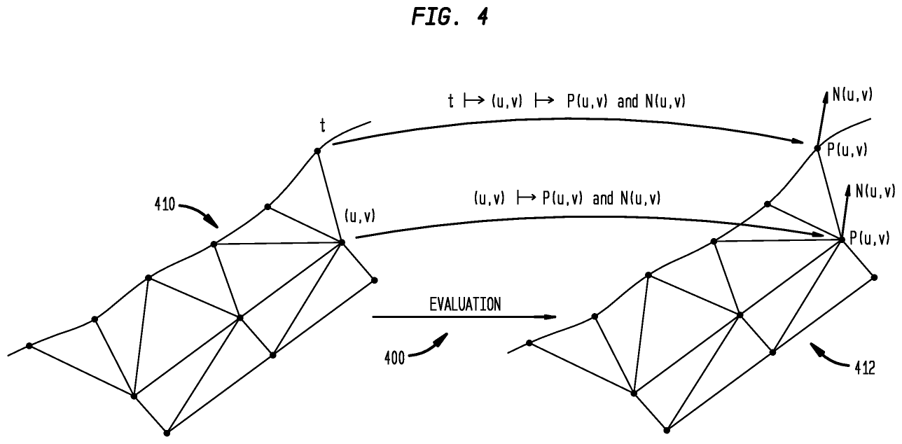

FIG. 4 illustrates an evaluation 400 of a model space mesh 412 from parameter space mesh 410, in accordance with disclosed embodiments. In parameter space mesh 410, the facet vertices are represented by curve and surface parameter values, and in the model space mesh 412, the facet vertices and normal are represented by 3D coordinates.

The model space mesh can be evaluated from the parameter space mesh, as shown FIG. 4. Note that model space mesh has exactly the same connectivity between mesh vertices, and only vertex geometry needs to be evaluated. The evaluation formula depends on the type of vertices: both curve evaluation and surface evaluation are needed to evaluate a curve-based vertex, while only surface evaluation is needed to evaluate a surface-based vertex.

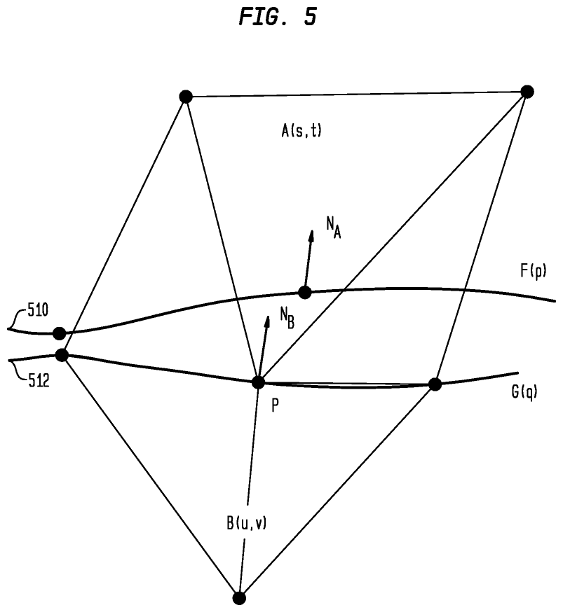

FIG. 5 illustrates evaluation of curve-based vertices to avoid cracks in accordance with disclosed embodiments. To avoid cracks in the evaluated model space mesh at the curve locations, some care needs be taken when evaluating curve-based vertices as shown in FIG. 5. Specifically, the evaluation of mesh vertex coordinates is always based on master curve geometry to ensure that the evaluated coordinates are always identical from both sides in order to avoid cracks. The evaluation of normal vector, however, is done on each surface for correct shading effect.

In the example of FIG. 5, assume that the curves F(p) and G(q) are known, as is the parameter value w. To get the 3D coordinates of the vertex, use (u,v)=G(w) and P=B(u,v).

To get the normal of facets on surface 512, use (u,v)=G(w) and N_{B}=N_{B}(u,v). To get the normal of faces on surface 510, use (s,t)=F(w) and N_{A}=N_{A}(s,t). N_{B}(u,v) can be calculated from surface derivative information of surface 512 as:

$${N}_{B} ( u , v ) = \frac{{B}^{u} ( u , v ) \times {B}^{v} ( u , v )}{‖ {B}^{u} ( u , v ) \times {B}^{v} ( u , v ) ‖}$$

N_{A}(s,t) can be similarly computed from surface derivative information of surface 510.

Various embodiments provide for the inclusion of parameter space information as part of vertex geometry description in the evaluated model space mesh, for the purpose of quickly figuring out new vertex geometry from existing vertex geometry based on B-Rep geometry.

The geometry of new vertex is figured out by first computing its parameter space value, and then evaluating that parameter value based on B-Rep geometry. This way the location of every new vertex is therefore guaranteed on lying on the B-Rep geometry.

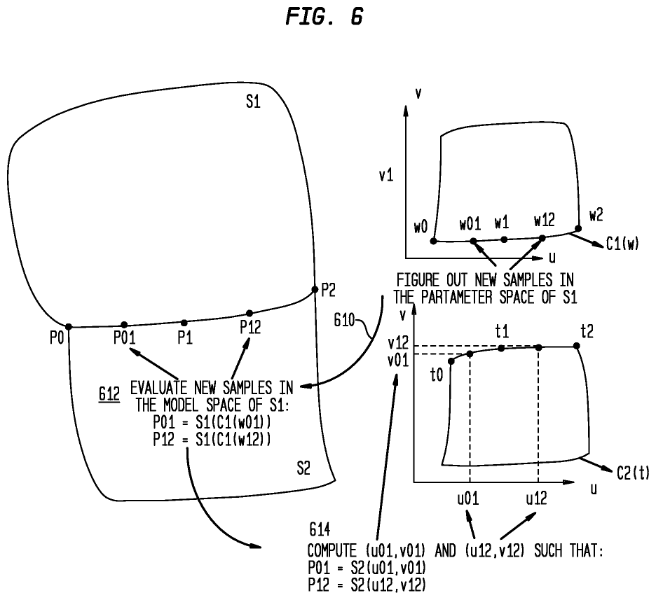

FIG. 6 illustrates an example of a process to determine or add new curve-based vertices between two curve-based vertices to refine a mesh. The geometry of new vertex is figured out by first computing its parameter space value, and then evaluating that parameter value based on B-Rep geometry.

At 610, the system determines new sample points in the parameter space of surface S1. Shown here, points w01 and w12 are the new vertices introduced by refinement. Different strategies can be used to decide values of w01 and w12.

At 612, the system evaluates the new samples in the model space of surface S1, so that P01=S1(C1(w01)) and P12=S1(C1(w12)). The refinement is propagated from S1 to S2 by first evaluating model space position, and then computing corresponding parameter space value on S2. Such propagation helps achieve better-quality normal on S2 in the refined mesh.

At 614, the system computes (u01,v01) and (u12,v12) such that P01=S2(u01,v01) and P12=S2(u12,v12).

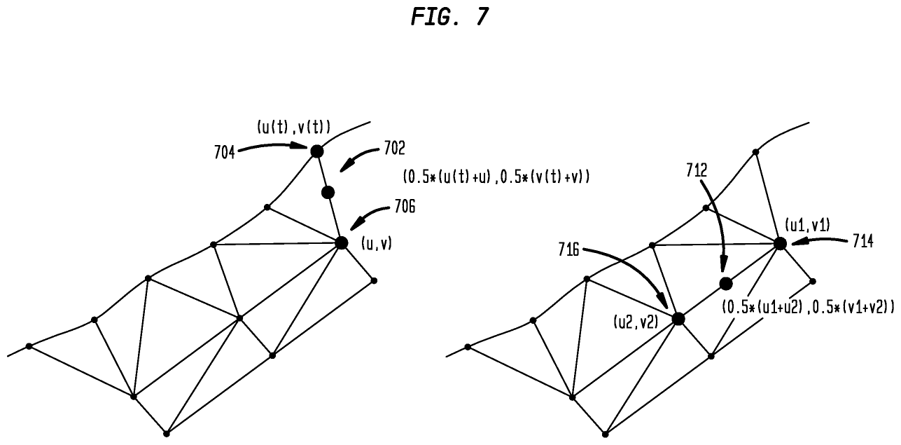

FIG. 7 illustrates an example of a process to determine or add new surface-based vertices between two surface-based vertices to refine a mesh. FIG. 7 illustrates computing a new surface-based vertex 702 between a curve-based vertex 704 and a surface-based vertex 706. This figure also illustrates computing a new surface-based verted 712 between two surface-based vertices 714 and 716.

The processes shown in FIGS. 6 and 7 are just sample implementations by picking the new vertex as the middle point in the parameter space. Other implementations are possible, including picking other point in the parameter space or adding more than one new vertex between two existing vertices. According to disclosed embodiments, by storing parameter space information as part of vertex geometry, computation of new vertex geometry is made simpler and quicker.

Moreover, the parameter space values of new vertices added as a result of refinement operation are kept as part of vertex representation in the refined mesh. This way the refined mesh can be further refined using the same algorithm, and still all the vertices of the further refined mesh are guaranteed on precisely lie on the B-Rep geometry.

An advantage of disclosed embodiments is the inclusion of parameter space triangle mesh in addition to lightweight B-Rep. This triangle mesh serves a unique role of producing the initial LOD by evaluation, and producing more detailed LODs by refinement. This is significantly different from all prior solutions and such design results in a geometry representation that can be effectively compressed, have good accuracy, maintains CAD surface information, and has the ability to quickly generate and refine LODs for display.

Disclosed embodiments also include new systems and methods for B-Rep based polygon mesh refinement, giving the ability to quickly generate a polygon mesh of higher fidelity from an existing polygon mesh based on B-Rep geometry. A polygon mesh of higher fidelity better approximates intended curved geometry and produces higher quality picture.

One approach for mesh refinement uses subdivision surfaces. Subdivision surfaces represent surface geometry procedurally as the limit surface resulting from an infinite number of iterative refinement operations applied on base polygon meshes. Unlike B-Spline surfaces, where the control mesh must have rectangular topology, the base polygon mesh of a subdivision surface can have arbitrary topology. However, the subdivision surface does not achieve C2 continuity at those special vertex locations where the mesh topology is not rectangular. Subdivision surfaces have been widely used in the movie industry where the models usually have an organic shape without sharp edges and where accurate geometry is less important than a pleasing visual effect. Modeling sharp edges using subdivision surfaces, however, is difficult because of the inherent smoothness of its basis functions. Producing subdivision surfaces from existing CAD models, represented as a set of connected trimmed surfaces, is also difficult. In addition, subdivision surface representation lacks the ability to explicitly represent analytic surface types such as cylinder or sphere where information such as radius carries important engineering information.

Another approach involves representing the object geometry as a collection of untrimmed low order parametric patches that interpolate a set of discrete samples on the B-Rep model. Such representation can be produced when G1 geometry continuity does not have to be maintained, but becomes more complex and much harder to produce if G1 continuity must be maintained. Such patch representation shares similar disadvantages with subdivision surface representation in that it only approximates B-Rep geometry from point position perspective, and does not keep important analytic representation.

Another approach involves a heuristic way of guessing curved geometry representation based on polygonal mesh vertex geometry and normal information. Refinement of the triangle mesh is achieved by adding new samples along the edges of the triangle or in the interior of the triangle based on derived curve and surface. The fundamental limitation of such an approach is that the tangent continuity is maintained only at the vertex locations of the initial mesh. The surface geometry is not G1 continuous across triangle edges. Such limitation can put a ceiling on the display quality of the refined mesh. This approach also shares the same problem as the other approaches in that it does not explicitly represent important analytic information.

Yet another approach is a static LOD approach that is used in current visualization formats such as JT. In this approach, multiple LODs of different fidelities are generated by tessellating the B-Rep and then explicitly written into the file. This way the application can choose to switch to a LOD of higher fidelity that is read from the file. In this approach, the level of LODs has to be determined at the file generation time, and writing more LODs into the file means larger file size due to duplication of information across different LODs.

Still approach is to generate LODs of different fidelities by tessellating B-Rep at run time. This is the approach taken by first generation ULP (ULP1) in JT. This approach helped greatly reduce the JT file size. In this approach, however, the loading performance is less than desired because of the inherent complexity of the tessellation operation and the resulting significant computation.

Disclosed embodiments address mesh refinement by writing a polygon mesh together with B-Rep, where the polygon mesh faithfully captures the B-Rep topology but only approximates the geometry at low fidelity. This low fidelity polygon mesh can be viewed a “blueprint” or “skeleton” on the B-Rep geometry that provides hint for how new samples may be added to the polygon mesh and how these new samples may be connected to existing mesh vertices. Such “incremental” way of producing higher fidelity polygon mesh from an existing lower fidelity one involves less computation than the alternative of starting from scratch.

In order to be able to quickly compute new vertex information, the “B-Rep address” of each mesh vertex is recorded as part of low fidelity polygon mesh in various embodiments. The form of “B-Rep address” depends on the type of mesh vertex, as shown in FIG. 3, above. The address of a curve-based vertex includes the curve the vertex is sampled from and the parameter on the curve, while that of a surface-based vertex includes the surface the vertex is sampled from and the parameters on the surface.

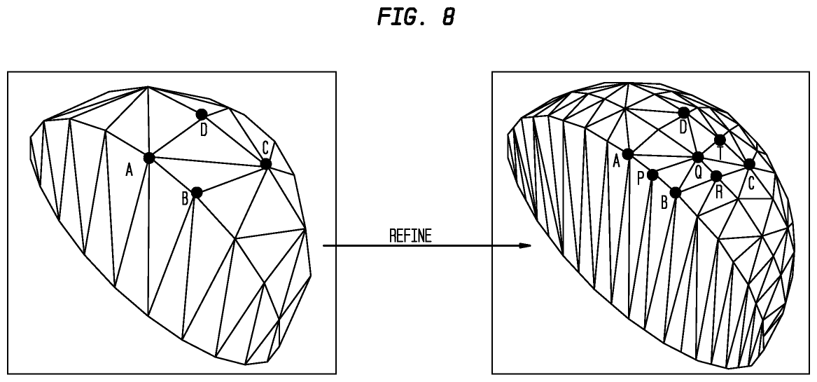

FIG. 8 illustrates a process of computing geometry of new vertices in different cases in accordance with disclosed embodiments. The different cases illustrated here include between two curve-based vertices (e.g. A and B), between a curve-based vertex and a surface-based vertex (e.g. A and C, or B and C), and between two surface-based vertices (e.g. C and D). While middle points in the parameter space are used in FIG. 8 to illustrate these disclosed examples, any point between two vertices may be chosen as the new vertex.

In this example, vertex A and B are on curve F(t)=(u(t), v(t)) with parameters t1 and t2 respectively, and vertex C and D is on surface S(u, v) with parameters (u1, v1) and (u2, v2) respectively.

New vertex P can be inserted between A and B, where P is also on curve F(t) with parameter value between t1 and t2, e.g., 0.5*(t1+t2).

New vertex Q can be inserted between A and C, where Q is also on surface S(u, v) with parameter value between (u(t1), v(t1)) and (u1, v1), e.g., (0.5*(u(t1)+u1), 0.5*(v(t1)+v1)).

New vertex R can be inserted between B and C, where R is also on surface S(u, v) with parameter value between (u(t2),v(t2)) and (u1, v1), e.g., (0.5*(u(t2)+u1), 0.5*(v(t2)+v1)).

New vertex T can be inserted between C and D, where T is also on surface S(u, v) with parameter value between (u1, v1) and (u2, v2) and, e.g., (0.5*(u1+u2), 0.5*(v1+v2)).

The model space geometry of a new vertex represented in parameter space can be computed using standard curve and surface evaluation depicted above in FIG. 4.

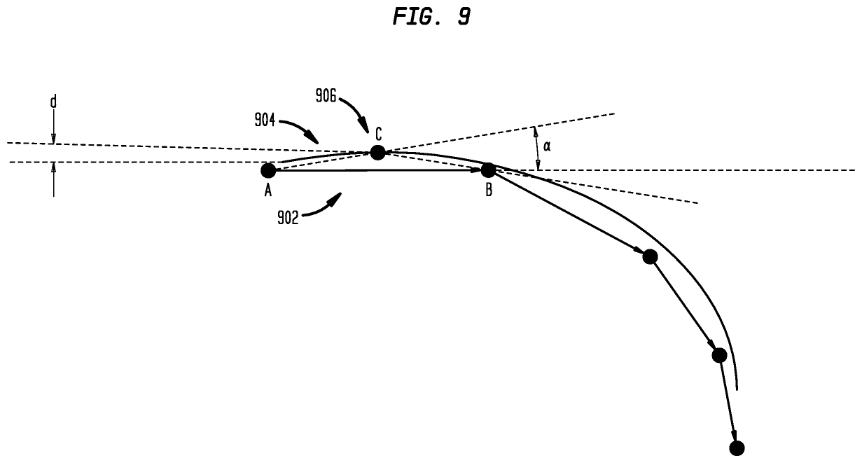

FIG. 9 illustrates that the fidelity of the refined mesh is controlled by two parameters.

A first parameter, cTol, controls the maximum allowed deviation of original curve geometry to edge AB 902, while a second parameter, aTol, controls the maximum allowed angle that can be formed between a candidate new edge and edge AB. A new vertex C 906 is added only if one or two illustrated by FIG. 9 are not satisfied: the deviation of vertex C 906 from line AB 902, d, is larger than preset tolerance cTol, and the angle formed by line AC 904 and line AB 902, α, is larger than preset tolerance aTol.

This process not only provides quantized numerical accuracy of the refined mesh, it also ensures that new vertices are only added at locations where the current mesh does a poor job of approximating original B-Rep geometry.

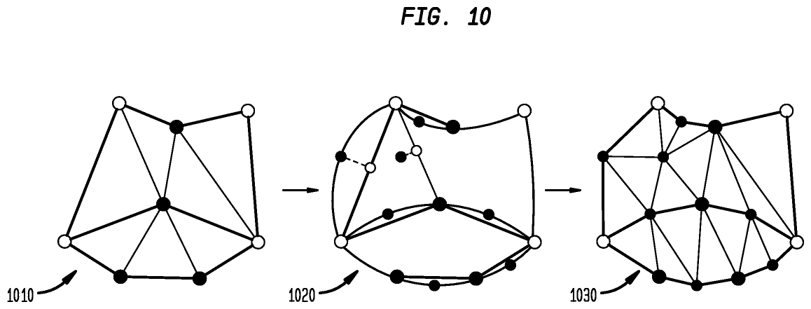

FIG. 10 illustrates a B-Rep mesh based on mesh refinement, according to disclosed embodiments. This includes the mesh 1010 before refinement, the mesh 1020 with curve/surface edge refinement, and the mesh 1030 after refinement. In this figure, solid vertices represent mesh vertices, open-circle vertices represent B-Rep vertices, straight lines represent the mesh (before, during, and after refinement), curved lines represent B-Rep curves, and vertices on B-Rep curves represent the added curve-based vertices, while added vertices not on curves represent added surface-based vertices.

For surfaces that have flat geometry along one parametric direction, e.g., plane, cylinder, cone, and swept surfaces, no new vertex is expected in the interior of the surface and very fast tessellation using specialized algorithm, e.g., monotone partitioning, is possible.

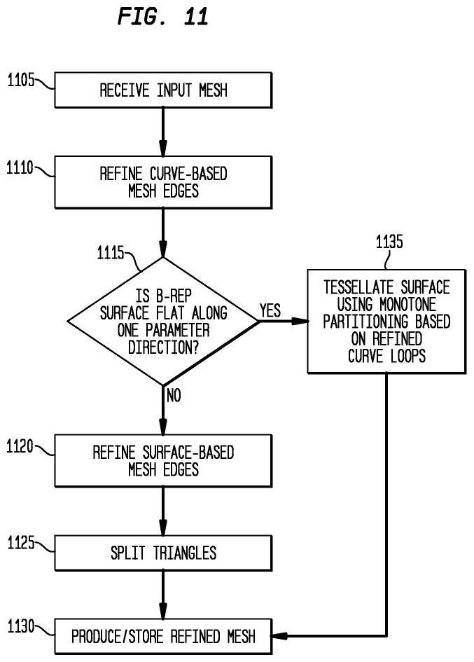

FIG. 11 illustrates a process in accordance with disclosed embodiments that uses a hybrid of specialized tessellation and facet split. Such a process, and the other processes described herein, can be performed by one or more data processing systems as described herein, referred to generically as the “system.”

The system receives an input mesh (1105).

The system refines curve-based mesh edges of the input mesh (1110). This can be performed as described herein. Note that references to simply the “mesh” in this process refers to the mesh as modified by previous processes.

The system determines if the B-Rep surface of the mesh is flat along one parameter direction (1115).

If the B-Rep surface of the mesh is flat along one parameter direction, the system tessellates the surface using monotone partitioning based on the refined curve loops of formed by the refined curve-based mesh edges (1135), then produces and/or stores the output refined mesh (1130).

If the B-Rep surface of the mesh is not flat along one parameter direction, the system refines the surface-based mesh edges of the mesh (1120). This can be performed as described herein.

The system splits the triangles of the mesh using added vertices (1125), then produces and/or stores the output refined mesh (1130).

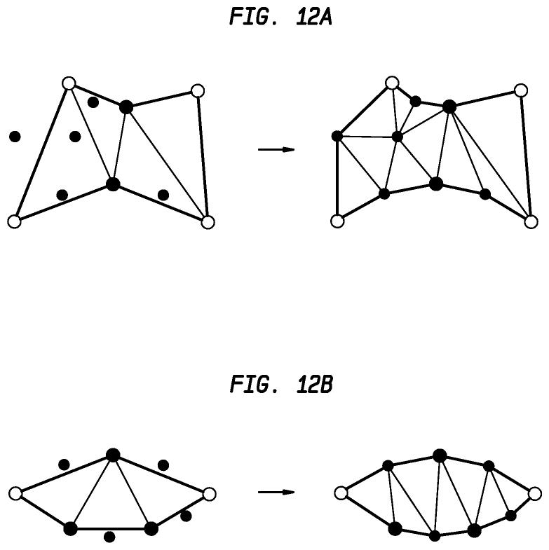

FIGS. 12A and 12B illustrate and compare two ways of connecting new vertices with existing vertices in accordance with disclosed embodiments. FIG. 12A illustrates refining the surface-based mesh edges and splitting triangles as in 1120-1125 above, and FIG. 12B illustrates tessellating the surface using monotone partitioning as in 1135.

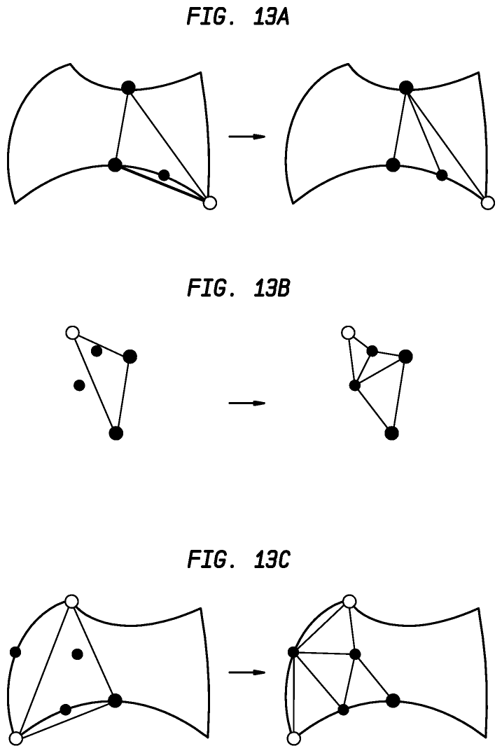

FIG. 13A-13C illustrate three cases of triangle splitting in accordance with disclosed embodiments. FIG. 13A illustrates one edge refined and split into two sub-triangles. FIG. 13B illustrates two edges refined and split into three sub-triangles. FIG. 13C illustrates three edges refined and split into four sub-triangles.

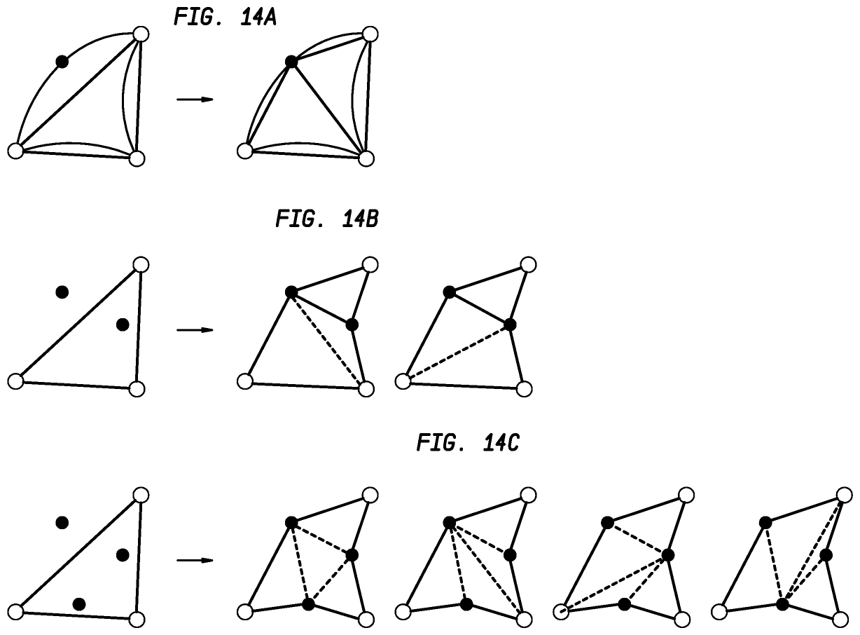

FIGS. 14A-14C illustrate optimal techniques for triangle splitting with new vertices using geometry-driven connectivity computation in accordance with disclosed embodiments. When two or three new vertices are inserted to the triangle edges, more than one way exist to connect these new vertices with existing vertices as shown in FIGS. 14A-14C. FIG. 14A illustrates the single case of a split into two sub-triangles. FIG. 14B illustrates two cases for a split into three sub-triangles. FIG. 14C illustrates four cases for a split into four sub-triangles. The dashed lines shown in FIGS. 14B-14C indicate the ambiguity. Such ambiguity is resolved by choosing the connectivity choice that results in highest geometric precision in the refined mesh, as computed as the sum of deviation errors (as shown in FIG. 9) of the dashed lines for each configuration.

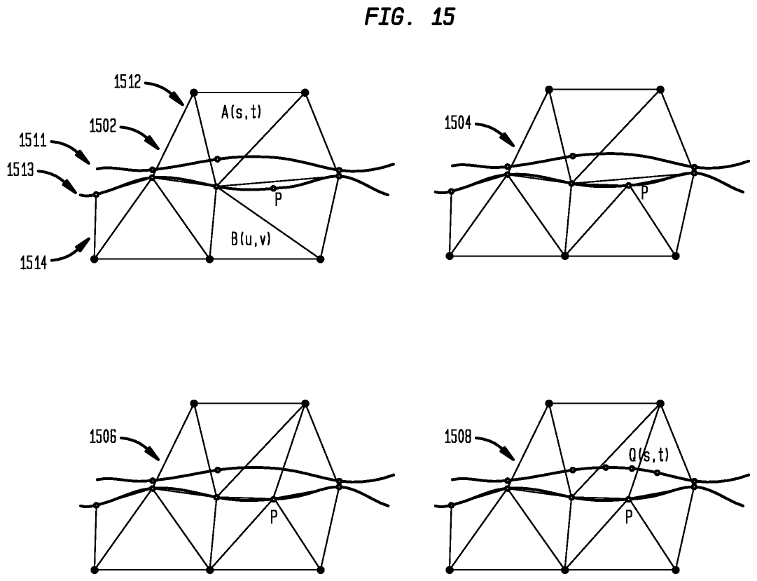

FIG. 15 illustrates a process for propagation of a refinement result from one surface to an adjacent surface. In this figure, curve 1511 is a parameter space curve according to p [symbol] (s(p),t(p)), and the surface 1512 above corresponding to curve 1511 has a parameterization (s,t) [symbol] A(s, t). Curve 1513 is a parameter space curve according to q [symbol] B(u(q),v(q)), and the surface 1514 below corresponding to curve 1513 has a parameterization (u,v,) [symbol] B(u,v).

At 1502, the system selects a parameter value \hat{q} and computes point P=B(u(\hat{q}),v(\hat{q}).

At 1504, the system constructs new facets for surface 1514. The system computes the vertex normals of these facets from surface 1514. The values (u, v) at P are known, so this can be performed using standard surface evaluation.

At 1506, the system constructs new facets for surface 1512. The system computes the facet vertices using point P.

At 1508, the system calculates the vertex normals for the new facets of surface 1512 (e.g., normal of surface 1512 at P) at (s,t)=(s(\hat{p}),t(\hat{p})) where A(s(\hat{p}),t(\hat{p}))≈P. This is point Q at parameter value \hat{p} on curve 1511. For example, point Q can be identified as the sample closest to P out of a fixed number of samples (e.g., 3).

A propagation process as in FIG. 15 provides the technical advantages and improvements of avoiding cracks and achieving good quality normal vector at the new vertex for each surface.

The technical advantages of the disclosed mesh refinement technique include enabling fast generation of a high-fidelity polygon mesh from B-Rep in CAD data. The resulting benefit is that only a single low-fidelity LOD needs to be included in the visualization file, with higher-fidelity LODs generated on the fly at runtime, resulting in an improved device that processes the CAD data faster while requiring less space. This not only reduces file size, but also simplifies the visualization file generation. In effect, this low-fidelity initial LOD has abstracted away all of the surface-trimming inherent in the B-Rep, leaving only computationally efficient, straightforward refinements and evaluations necessary to refine the mesh. The technical features that contribute to the high fidelity of the refined mesh lie in the fact that B-Rep geometry is used to precisely compute the geometry of every new mesh vertex. On the other hand, fast refinement performance is achieved by refining an existing mesh in the parameter space (instead of re-tessellating the whole B-Rep).

Disclosed embodiments also include techniques for parameter space polygon mesh compression. The disclosed processes produce effective compression of a polygon mesh represented in the parameter space of B-Rep, for the purpose of achieving very small file size. These techniques are particularly effective for compression of parameter space mesh representation in ULP2 as described herein.

While mesh compression is a well-studied topic, existing approaches deal with mesh represented in the model space with no interaction with B-Rep. For example, mesh data in some systems includes an approach that efficiently encodes the topological connectivity between mesh facets. By contrast, disclosed approaches are intended for compressing parameter space polygon mesh with the presence of B-Rep. The advantages of the various embodiments include simplicity, runtime efficiency, and ability to accommodate high level primitives such as tristrips. Disclosed embodiments achieve very small file size by leveraging B-Rep information to more effectively compress parameter space polygon mesh information.

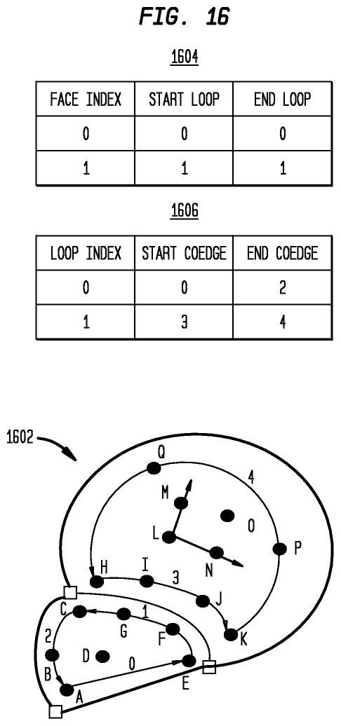

FIG. 16 illustrates a B-Rep with sample points in the parameter space mesh. In this figure squared vertices represent B-Rep vertices, and circular points represent vertex records. The example B-Rep 1602 has two faces, and each face has one loop. The loop in the first face has three coedges (labeled as 0, 1, and 2), while the loop in the second face has two coedges (labeled as 3 and 4). Details of B-Rep surface geometry (associated with each B-Rep face) and parameter space curve geometry (associated with each B-Rep coedge) are not illustrated since their precise form is not relevant to this discussion. It is assumed that each B-Rep face has its own surface, each coedge has its own parameter space curve. Record 1604 illustrates face indices with corresponding start and end loops, and record 1606 illustrates loop indices with corresponding start and end coedges. These records, and other records as described herein, can be stored by the system as part of a lightweight CAD data file, ULP2 file, or other file or database as described herein, and can be stored in any of the storage mediums or memories described herein.

Also illustrated in FIG. 16 are the sample points on each of the surfaces and parameter space curves. For example, a first surface has a single sample point in its interior labelled as “D”, while the first parameter space curve has one sample point labelled as “A”. Connecting the sample points together forms a polygon mesh, also shown above in the model space. The generation of these sample points and the connectivity between these points from B-Rep is typically done by a step called tessellation. Tessellation techniques are known to those of skill in the art, and the described techniques do not depend on particular type of tessellation.

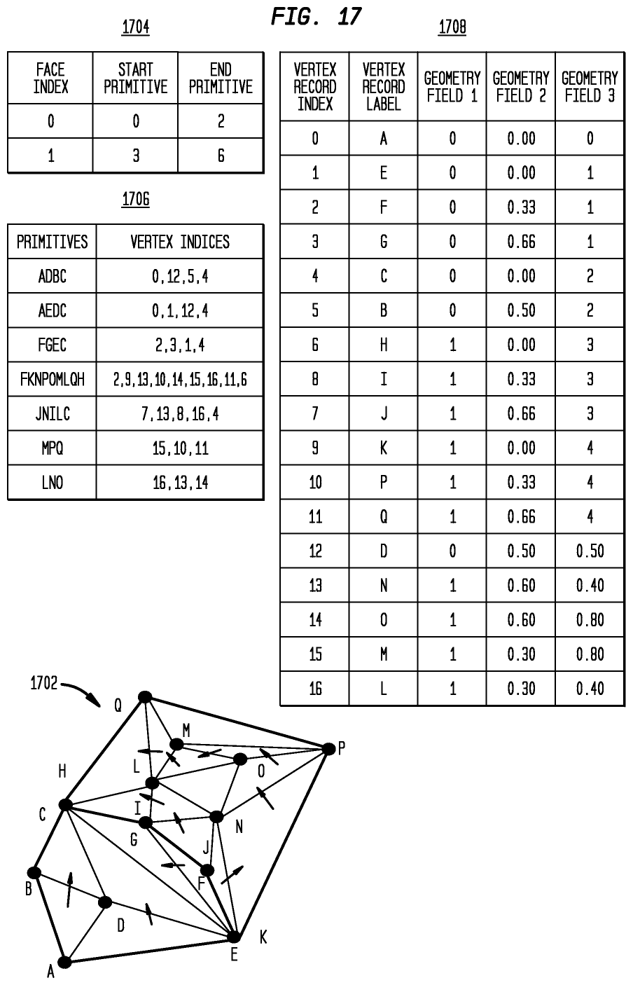

FIG. 17 illustrates a polygon mesh representation in accordance with disclosed embodiments, including a vertex record table 1708 ordered by its originating B-Rep entity type and index. Each circular point in this figure represents a unique vertex record. The geometry of each mesh vertex is described by the originating B-Rep entity and the sample parameter in the parameter space. The illustration in FIG. 17 assumes normalized parameter space: the parameter range of each parameter space curve and both parameter directions of each surface is always 0.0 to 1.0. A sample in the interior of a B-Rep surface is represented by three pieces of information: the index of B-Rep surface from which the sample came from, and the u and v parameter values of B-Rep surface that the sample corresponds to. For example, vertex record “D” is sampled from surface 0, with u parameter 0.5 and v parameter 0.5. On the other hand, a sample on a parameter space curve is also represented by three pieces of information: the index of B-Rep loop from which the sample came from, the parameter value of the parameter space curve the sample corresponds to, and the index of parameter space curve from which the sample came from. For example, vertex record “P” is sampled from parameter space curve 4 on loop 1 at parameter 0.33.

The information of each sample point is referred to a vertex record, and the collection of vertex records forms the “vertex record table” 1708 describing mesh geometry. On the other hand, “unique vertex record” refers to a unique model space location in 3D space. Multiple vertex records can correspond to the same unique vertex record. For example, vertex records “C” and “H” illustrated in vertex record table 1708 of FIG. 17 are associated with the same unique vertex record. Each vertex record produces its own normal vector based on its underlying surface geometry to achieve proper shading effect. For example, sample “C” is used to evaluate the normal vector based on surface geometry of first face, while sample “H” is used to evaluate the normal vector based on surface geometry of second face.

A tristrip is frequently employed to improve the compactness of the mesh representation. In the mesh 1702 illustrated in FIG. 17, tristrip “ADBC” represents triangles “ADB” and “BDC” in a more compact way. A tristrip describing one or more connected triangles is called a “primitive.” It is assumed that a single primitive only contains triangles that are originated from the same B-Rep face. This way the mesh can be organized hierarchically: a mesh consists of one or more face groups, each face group consists one or more primitive, and each primitive consists of one or more triangles. These features are illustrated, for example, in face table 1704 and tristrip table 1706.

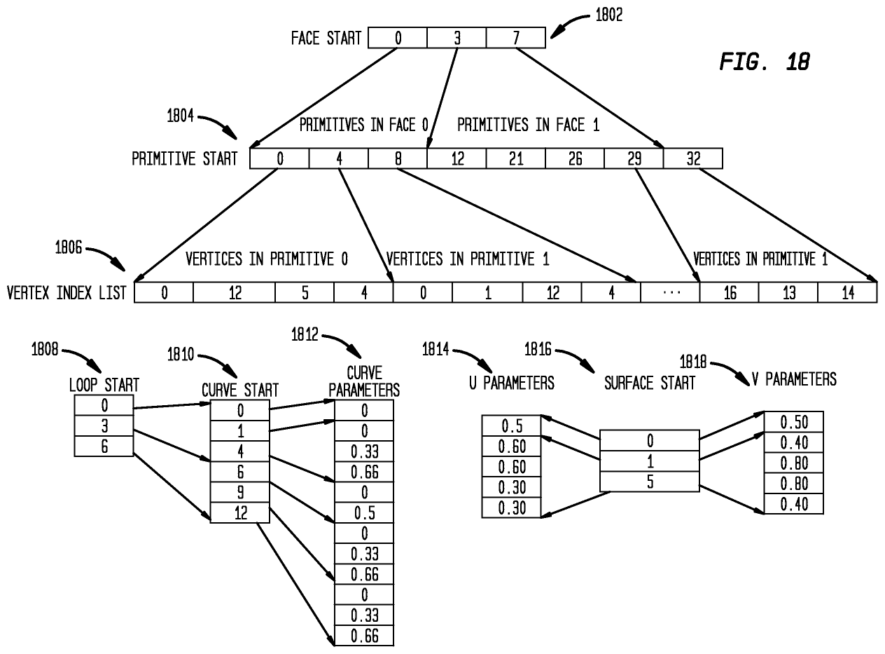

FIG. 18 illustrates a technique for serializing a mesh representation in accordance with disclosed embodiments, such as the mesh 1702 in FIG. 17. This process takes advantage of hierarchical structure of mesh representation and the ordering of vertex records (all vertex records originated from curves are ordered before records originated from interior of surfaces. More over all the records are first ordered by increasing curve or surface index. Curve vertex records are further ordered by increasing parameter values). In this process, the nine arrays, “Face Start” 1802, “Primitive Start” 1804, “Vertex Index List” 1806, “Loop Start” 1808, “Curve Start” 1810, “Curve Parameters” 1812, “Surface Start” 1816, “U Parameters” 1814, and “V Parameters” 1818, shown in FIG. 18 need to be written. The array “Vertex Index List” 1806 can contain random list of integers that have a wide range. The entropy of this array is high and therefore the information cannot be very effectively compressed.

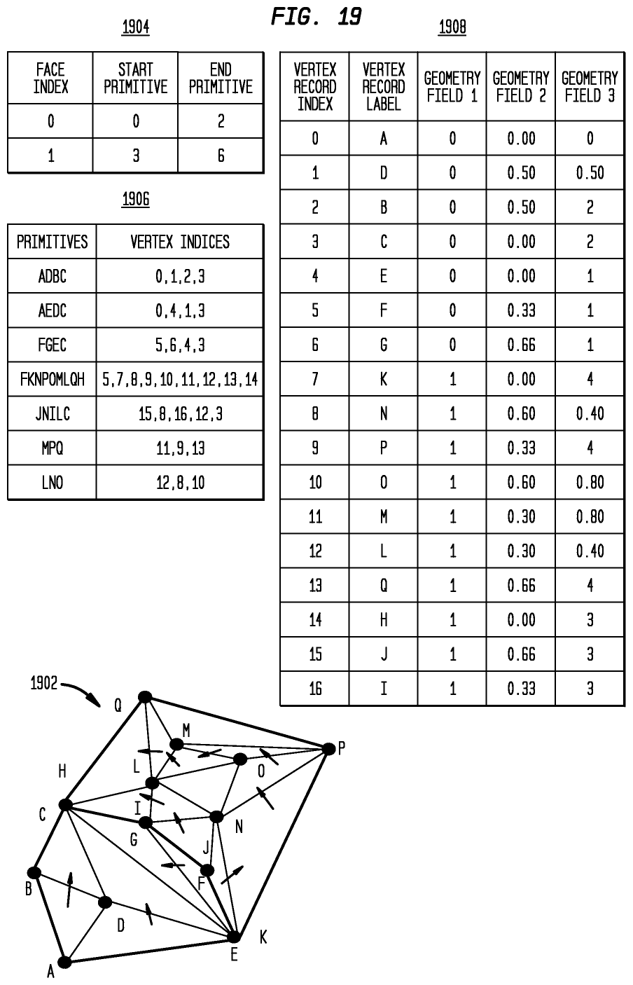

FIG. 19 illustrates ordering of vertex records in accordance with disclosed embodiments. Disclosed embodiments include processes that more effectively compress the mesh information by properly leveraging B-Rep information shown in FIG. 19. This figure illustrates a polygon mesh representation for a mesh 1902 in accordance with disclosed embodiments, including a vertex record table 1908 ordered by its originating B-Rep entity type and index, and including in face table 1904 and tristrip table 1906. Each circular point in this figure represents a unique vertex record. More specifically the vertex records in vertex record table 1908 are ordered in the sequence that they are traversed in “width first” fashion in the face-primitive-vertex hierarchical mesh description. For example, vertex E is fifth unique vertex record that is encountered during such traversal and therefore it is assigned as record 4 in the table (record index is 0 based in this example). This way the index of each record can be computed from their values when the records are sequentially read from disk. If the record is found in the table containing records that have already been read, then the index of the record can be found from the table. If the record is not found in the table, then its index is the number of records in the table. This provides a distinct advantage and device improvement over other techniques in that it avoids the need of explicitly writing the index of vertex records.

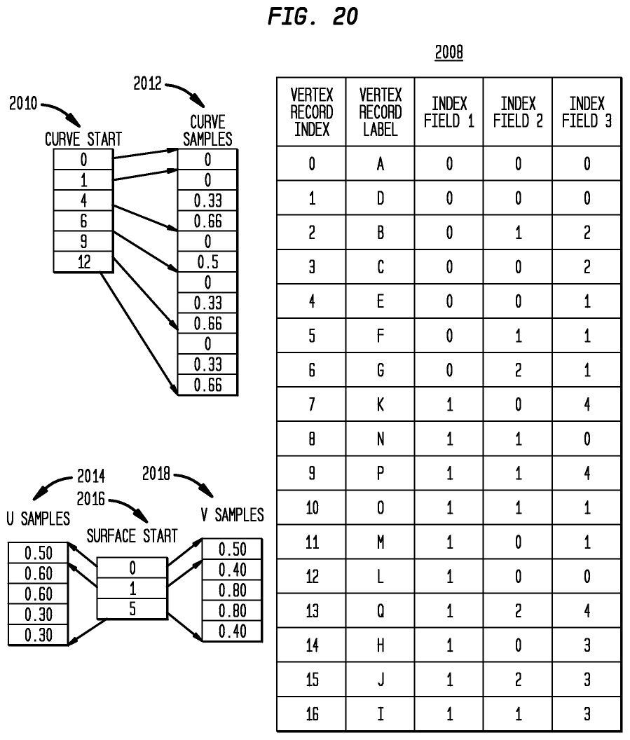

FIG. 20 illustrates index based vertex geometry with reference to parameter value tables, in accordance with disclosed embodiments. Shown here are vertex record table 2008, and arrays as above—“Curve Start” 2010, “Curve Samples” 2012 (corresponding to the curve parameters above), “Surface Start” 2016, “U Samples” 2014 (corresponding to the U parameters above), and “V Samples” 2018 (corresponding to the V parameters above).

Note that the values of some of the index fields can be still quite large (for example the parameter curve index value in “index field 3” can still have large value because number of parameter space curves in a big B-Rep model can still be large) and therefore hard to compress. On the other hand, the topological relation between faces, loops, and coedges, i.e., which loop is in which face and which coedge is in which loop, is already represented in B-Rep. In various embodiments, a “relative index” instead of “absolute index” be used, where “relative index” refers to the index of an entity in its parent entity. For example, parameter space curve 4 in the B-Rep has relative index of 1 in its owner loop (loop 1 of the B-Rep). Using “relative index” significantly reduces the magnitude of indices in the vertex representation which introduces much more duplication of information across different vertices. Put in another way, using “relative index” reduces the information entropy which enables more effective entropy coding despite the fact that more numbers are being written.

Note also that parameter values always increase monotonically along a parameter direction. Moreover, such increase is frequently uniform in practice. Therefore the parameter values along the same parameter direction on the same geometry (curve or surface) can be simplified by computing the differences between adjacent parameter values. Such manipulation increases the chance that the values in the parameter tables repeat and therefore further reduces their entropy values.

Note also that the interior surface samples frequently are in a rectangular grid in the parameter space and therefore only distinct values that represent sampling along U and V parameter directions need be recorded. Moreover, similar difference operation can be performed because the parameter values along U and V directions are also always monotonic.

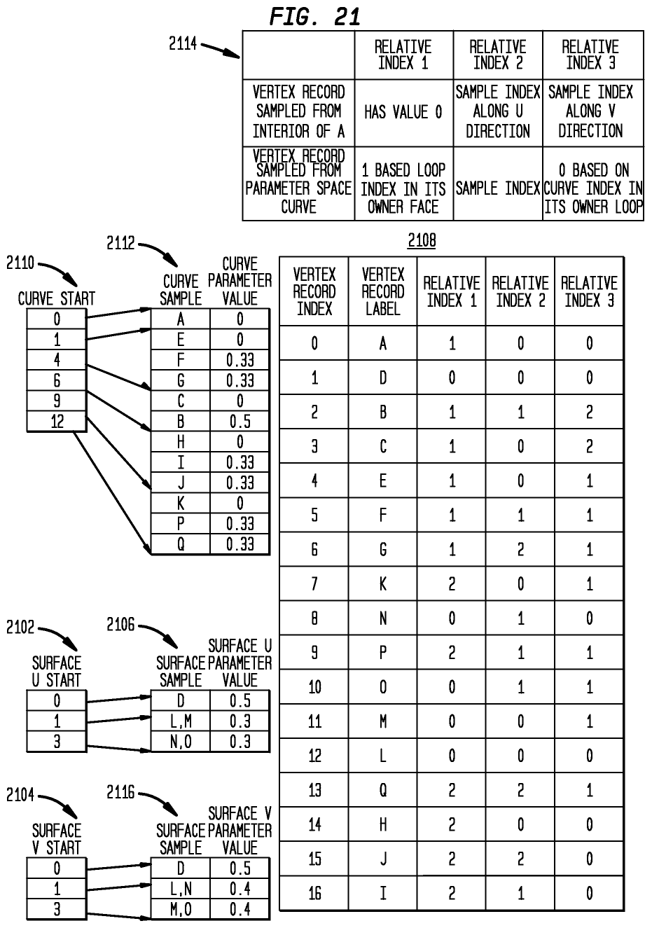

FIG. 21 illustrates compression-friendly vertex geometry representations with relative indices in accordance with disclosed embodiments. Each vertex in the vertex record table 2108 is represented by three “relative indices”, as illustrated in relative index table 2114. If the first index has value 0, then it is a record sampled from the interior of a surface (note that surface index information of each record is already known from the hierarchical mesh representation shown in FIG. 2). Further second and third relative indices would indicate the sample index along U and V parameter directions respectively. Shown here are also curve start table 2110, curve sample table 2112, surface U start table 2102, surface U sample table 2106, surface V start table 2104, and surface V sample table 2116.

For example, vertex record “D” is sampled from a surface, and its sample indices along both U and V parameter directions are 0. If the first index has value larger than 0, then this indicates that this record is sampled from a parameter space curve. In addition the value of first index indicates 1-based (relative) loop index in its owner face. Second index represents the sample index along the parameter space curve, while third index represents 0-based (relative) index of parameter space curve within its owner loop. For example vertex record “P” is the second sample on the second parameter space curve on the first loop of its owner face, resulting in relative index 1 to have value 1 (1-based relative loop index), relative index 2 to have value 1 (second sample), relative index 3 to have value 1 (0-based relative curve index). Note that disclosed embodiments do not depend on the sequence between these three relative indices, and what is shown in FIG. 21 is just one way of arranging these indices. One important observation is that the entropies of the vertex record table and the parameter tables are significantly reduced, due to more duplication of values across different entries of both tables. Such reduction of entropy is more significant for real models, where a single B-Rep can contain hundreds of thousands of parameter space curves. Such reduction of entropy can be effectively leveraged by compression algorithms such as arithmetic coding to achieve very small file size.

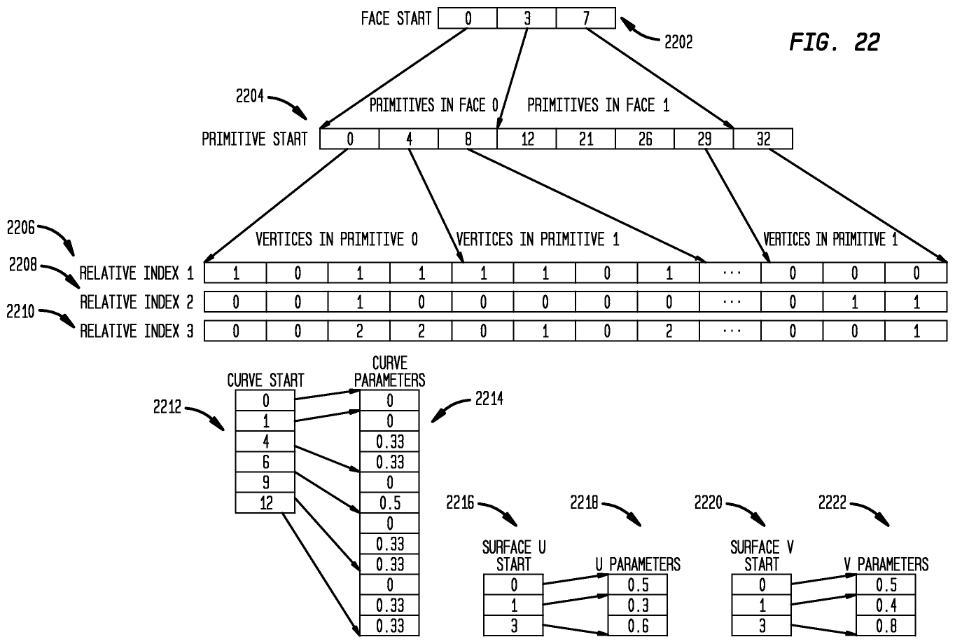

FIG. 22 illustrates polygon mesh serialization using relative indices, including specific pieces of information that can written as part of mesh representation as disclosed herein. Eleven different arrays are written: “Face Start” 2202, “Primitive Start” 2204, “Relative Index 1” 2206, “Relative Index 2” 2208, “Relative Index 3” 2210, “Curve Start” 2212, “Curve Parameters” 2214, “Surface U Start” 2216, “U Parameters” 2218, “Surface V Start” 2220, and “V Parameters” 2222. Note that the “Vertex Index List” 1806 array shown in FIG. 18 is split into three relative index arrays in FIG. 22. While this approach writes more numbers when relative index arrays are used, the overall entropy is greatly reduced which leads to smaller file size after compression.

During polygon mesh deserialization the “vertex index list” shown in FIG. 18 and the vertex record table shown in FIG. 21 can be computed from three relative index arrays shown in FIG. 22. These two pieces of information can be computed at the same time in an interleaved fashion.

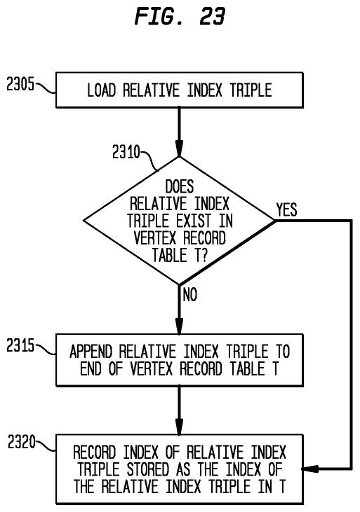

FIG. 23 illustrates a process for computing a vertex index list and vertex record table during polygon mesh deserialization from three relative index arrays. Note that the correctness of such computation is ensured by the specific way that the vertex records are ordered as shown in FIG. 19.

The system loads a relative index triple (r1 r2 r3) (2305).

The system determines whether the relative index triple (r1 r2 r3) exists in the vertex index table T (2310).

When the relative index triple (r1 r2 r3) exists in the vertex index table T, the system records the index of the relative index triple (r1 r2 r3) as the index of relative index triple (r1 r2 r3) in the vertex index table T (2320).

When the relative index triple (r1 r2 r3) does not exist in the vertex index table T, the system appends the relative index triple (r1 r2 r3) to the end of the vertex index table T (2315), then the system records the index of the relative index triple (r1 r2 r3) as the index of relative index triple (r1 r2 r3) in the vertex index table T (2320).

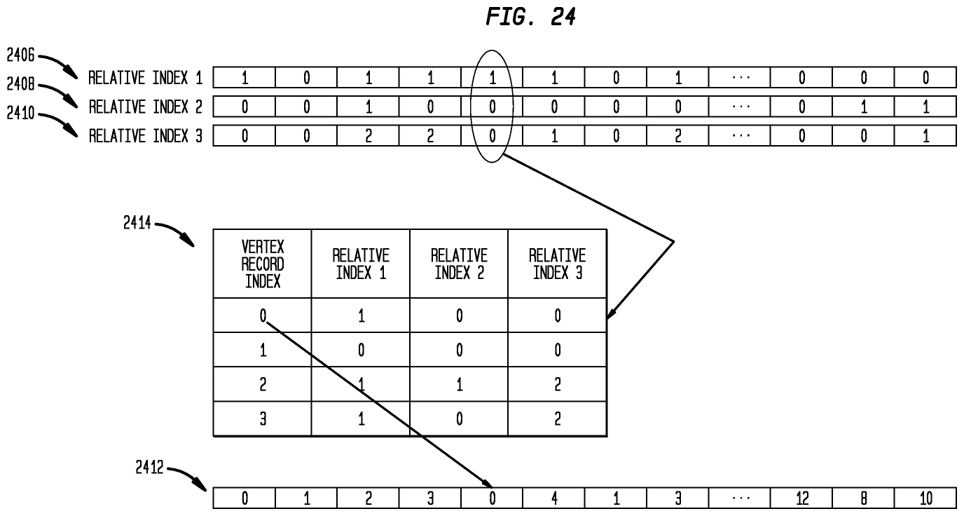

FIG. 24 shows an example of the computation shown in FIG. 23 for better illustration of the process in accordance with disclosed embodiments. More specifically, the example shown in FIG. 24 illustrates how the vertex index is decided when the vertex record, expressed in the form of triple relative indices, already exists in the vertex record table. Shown here are relative index table 2414, relative index 1 table 2406, relative index 2 table 2408, relative index 3 table 2410, and deserialization output 2412.

Disclosed mesh compression techniques achieve very good compression for parameter space polygon mesh representation. As a result, file size becomes significantly smaller. Smaller file size leads to better performance especially when the file is located remotely due to reduced network transmission needs. Technical features that contribute to the small file size include the particular way the polygon mesh information is transformed and organized to facilitate entropy reduction. One important aspect of disclosed embodiments is leveraging B-Rep topology to reduce information entropy of a tessellated polygon mesh. Disclosed embodiments include processes and techniques that transform polygon mesh representation for the purpose of reducing information entropy during serialization to achieve small file size on disk, and steps and algorithms that recover its canonical representation from the reduced entropy form on disk during deserialization.

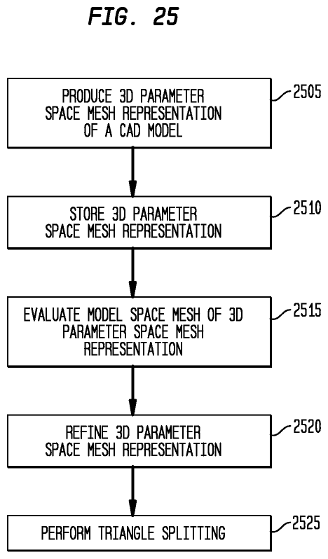

FIG. 25 depicts a flowchart of a process in accordance with disclosed embodiments that may be performed, for example, by a CAD, PLM, PDM or other data processing system.

The system produces a 3D parameter space mesh representation of a CAD model (2505).

The system stores the 3D parameter space mesh representation of the CAD model (2510).

The system can evaluate a model space mesh of the 3D parameter space mesh representation by evaluating the plurality of curve-based vertices and by evaluating the plurality of surface-based vertices (2515).

The system can refine the 3D parameter space mesh representation by computing geometry of new vertices between two curve-based vertices, between a curve-based vertex and a surface-based vertex, or between two surface-based vertices (2520). This can include adding new curve-based vertices to the 3D parameter space mesh representation or adding new surface-based vertices to the 3D parameter space mesh representation. The refinement can be performed using a first parameter that defines a maximum allowed deviation of original curve geometry to an existing edge, and using a second parameter that defines a maximum allowed angle that can be formed between a candidate new edge and an existing edge.

The system can perform triangle splitting according to vertices added to the 3D parameter space mesh representation (2525).

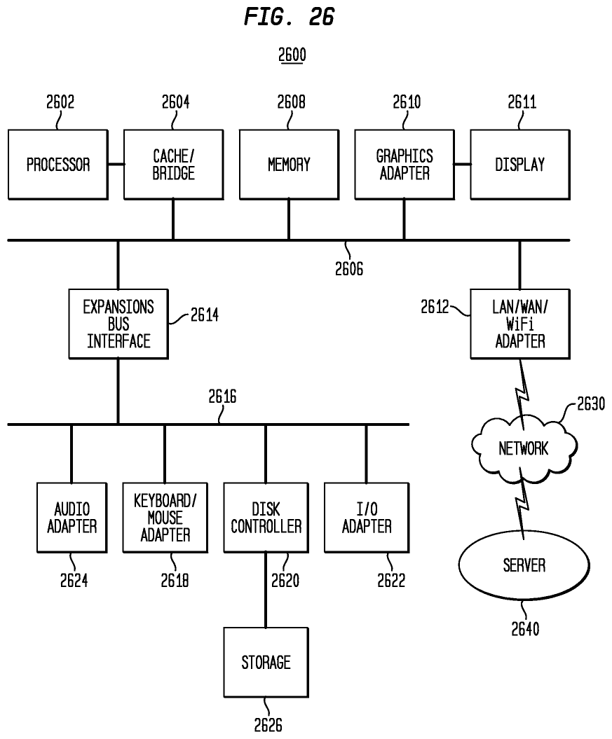

FIG. 26 illustrates a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 2602 connected to a level two cache/bridge 2604, which is connected in turn to a local system bus 2606. Local system bus 2606 may be, for example, a peripheral component interconnect (PCI) architecture bus. Also connected to local system bus in the depicted example are a main memory 2608 and a graphics adapter 2610. The graphics adapter 2610 may be connected to display 2611.

Other peripherals, such as local area network (LAN)/Wide Area Network/Wireless (e.g. WiFi) adapter 2612, may also be connected to local system bus 2606. Expansion bus interface 2614 connects local system bus 2606 to input/output (I/O) bus 2616. I/O bus 2616 is connected to keyboard/mouse adapter 2618, disk controller 2620, and I/O adapter 2622. Disk controller 2620 can be connected to a storage 2626, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 2616 in the example shown is audio adapter 2624, to which speakers (not shown) may be connected for playing sounds. Keyboard/mouse adapter 2618 provides a connection for a pointing device (not shown), such as a mouse, trackball, trackpointer, touchscreen, etc.

Those of ordinary skill in the art will appreciate that the hardware depicted in FIG. 26 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 2612 can be connected to a network 2630 (not a part of data processing system 2600), which can be any public or private data processing system network or combination of networks, as known to those of skill in the art, including the Internet. Data processing system 2600 can communicate over network 2630 with server system 2640, which is also not part of data processing system 2600, but can be implemented, for example, as a separate data processing system 2600.

Of course, those of skill in the art will recognize that, unless specifically indicated or required by the sequence of operations, certain steps in the processes described above may be omitted, performed concurrently or sequentially, or performed in a different order. Similarly, the various processes and operations disclosed herein may be combined, in whole or in part, with other processes and operations as disclosed.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 2600 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle. The use of terms such as (but not limited to) “mechanism,” “module,” “device,” “unit,” “component,” “element,” “member,” “apparatus,” “machine,” “system,” “processor,” or “controller,” within a claim is understood and intended to refer to structures known to those skilled in the relevant art, as further modified or enhanced by the features of the claims themselves, and is not intended to invoke 35 U.S.C. § 112(f).

What is claimed is:

1. A method performed by a data processing system, comprising:
producing a three-dimensional (3D) parameter space mesh representation of a computer-aided design (CAD) model, wherein:
the 3D parameter space mesh representation includes a plurality of curve-based vertices and a plurality of surface-based vertices,
each curve-based vertex corresponds to a boundary-representation (B-Rep) curve and is represented by a reference to a curve of a surface of the 3D CAD model and by at least one curve parameter value, and
each surface-based vertex corresponds to a B-Rep surface and is presented as a reference to a respective surface of the 3D CAD model and a plurality of parameters on the respective surface; and
storing the 3D parameter space mesh representation of the CAD model.

2. The method of claim 1, further comprising evaluating a model space mesh of the 3D parameter space mesh representation by evaluating the plurality of curve-based vertices and by evaluating the plurality of surface-based vertices.

3. The method according to claim 1, further comprising adding new curve-based vertices to the 3D parameter space mesh representation.

4. The method according to claim 1, further comprising adding new surface-based vertices to the 3D parameter space mesh representation.

5. The method according to claim 1, further comprising refining the 3D parameter space mesh representation by computing geometry of new vertices between two curve-based vertices, between a curve-based vertex and a surface-based vertex, or between two surface-based vertices.

6. The method according to claim 1, further comprising refining the 3D parameter space mesh representation using a first parameter that defines a maximum allowed deviation of original curve geometry to an existing edge and using a second parameter that defines a maximum allowed angle that can be formed between a candidate new edge and an existing edge.

7. The method according to claim 1, further comprising performing triangle splitting according to vertices added to the 3D parameter space mesh representation.

8. The method according to claim 1, wherein the 3D parameter space mesh representation includes a vertex record table and a plurality of relative indices.

9. A data processing system comprising:
a processor; and
an accessible memory, the data processing system particularly configured to:
produce a three-dimensional parameter space mesh representation of a computer-aided design model, wherein:
the 3D parameter space mesh representation includes a plurality of curve-based vertices and a plurality of surface-based vertices,
each curve-based vertex corresponds to a boundary-representation curve and is represented by a reference to a curve of a surface of the 3D CAD model and by at least one curve parameter value, and
each surface-based vertex corresponds to a B-Rep surface and is presented as a reference to a respective surface of the 3D CAD model and a plurality of parameters on the respective surface; and
store the 3D parameter space mesh representation of the CAD model.

10. (canceled)

11. The data processing system of claim 9, wherein the data processing system is further configured to evaluate a model space mesh of the 3D parameter space mesh representation by evaluating the plurality of curve-based vertices and by evaluating the plurality of surface-based vertices.

12. The data processing system of claim 9, wherein the data processing system is further configured to add new curve-based vertices to the 3D parameter space mesh representation.

13. The data processing system of claim 9, wherein the data processing system is further configured to add new surface-based vertices to the 3D parameter space mesh representation.

14. The data processing system of claim 9, wherein the data processing system is further configured to refine the 3D parameter space mesh representation by computing geometry of new vertices between two curve-based vertices, between a curve-based vertex and a surface-based vertex, or between two surface-based vertices.

15. The data processing system of claim 9, wherein the data processing system is further configured to refine the 3D parameter space mesh representation using a first parameter that defines a maximum allowed deviation of original curve geometry to an existing edge, and using a second parameter that defines a maximum allowed angle that can be formed between a candidate new edge and an existing edge.

16. The data processing system of claim 9, wherein the data processing system is further configured to perform triangle splitting according to vertices added to the 3D parameter space mesh representation.

17. The data processing system of claim 9, wherein the 3D parameter space mesh representation includes a vertex record table and a plurality of relative indices.

18. A non-transitory computer-readable medium encoded with executable instructions that, when executed, cause one or more data processing systems to:
produce a three-dimensional parameter space mesh representation of a computer-aided design model, wherein:
the 3D parameter space mesh representation includes a plurality of curve-based vertices and a plurality of surface-based vertices,
each curve-based vertex corresponds to a boundary-representation curve and is represented by a reference to a curve of a surface of the 3D CAD model and by at least one curve parameter value, and
each surface-based vertex corresponds to a B-Rep surface and is presented as a reference to a respective surface of the 3D CAD model and a plurality of parameters on the respective surface; and
store the 3D parameter space mesh representation of the CAD model.

19. The non-transitory computer-readable medium of claim 18, wherein the executable instructions further cause the one or more data processing systems to evaluate a model space mesh of the 3D parameter space mesh representation by evaluating the plurality of curve-based vertices and by evaluating the plurality of surface-based vertices.

20. The non-transitory computer-readable medium of claim 18, wherein the executable instructions further cause the one or more data processing systems to add new curve-based vertices to the 3D parameter space mesh representation.

21. The non-transitory computer-readable medium of claim 18, wherein the executable instructions further cause the one or more data processing systems to add new surface-based vertices to the 3D parameter space mesh representation.

22. The non-transitory computer-readable medium of claim 18, wherein the executable instructions further cause the one or more data processing systems to refine the 3D parameter space mesh representation by computing geometry of new vertices between two curve-based vertices, between a curve-based vertex and a surface-based vertex, or between two surface-based vertices.

23. The non-transitory computer-readable medium of claim 18, wherein the executable instructions further cause the one or more data processing systems to refine the 3D parameter space mesh representation using a first parameter that defines a maximum allowed deviation of original curve geometry to an existing edge, and using a second parameter that defines a maximum allowed angle that can be formed between a candidate new edge and an existing edge.

24. The non-transitory computer-readable medium of claim 18, wherein the executable instructions further cause the one or more data processing systems to perform triangle splitting according to vertices added to the 3D parameter space mesh representation.

25. The non-transitory computer-readable medium of claim 18, wherein the 3D parameter space mesh representation includes a vertex record table and a plurality of relative indices.
